(19) United States
(12) Patent Application Publication
(10) Pub. No.: US 2013/0098832 A1
(43) Pub. Date: Apr. 25, 2013

(54) SEMI-PERMEABLE COMPOSITE MEMBRANE

(71) Applicants: Hideto Matsuyama, Kobe-shi (JP); Yoshikage Ohmukai, Kobe-shi (JP); Harutoki Shimura, Otsu-shi (JP); Masahiro Henmi, Otsu-shi (JP); Hiroki Tomioka, Otsu-shi (JP); Koji Nakatsuji, Otsu-shi (JP); Masaaki Imanishi, Kobe-shi (JP)

(72) Inventors: Hideto Matsuyama, Kobe-shi (JP); Yoshikage Ohmukai, Kobe-shi (JP); Harutoki Shimura, Otsu-shi (JP); Masahiro Henmi, Otsu-shi (JP); Hiroki Tomioka, Otsu-shi (JP); Koji Nakatsuji, Otsu-shi (JP); Masaaki Imanishi, Kobe-shi (JP)

(73) Assignees: TORAY INDUSTRIES, INC., Tokyo (JP); NATIONAL UNIVERSITY CORPORATION KOBE UNIVERSITY, Kobe-shi, Hyogo (JP)

(21) Appl. No.: 13/643,698

(22) PCT Filed: Apr. 14, 2011
(86) PCT No.: PCT/JP2011/059236

§ 371 Date: Dec. 18, 2012

(30) Foreign Application Priority Data
Apr. 28, 2010 (JP) 2010-103272

(51) Int. Cl. B01D 69/12

(52) U.S. Cl. CPC B01D 69/125
USPC 210/489; 427/244

(57) ABSTRACT

Provided is a semi-permeable composite membrane which exhibits both high durability and high solute-removal and water-permeation performances. The semi-permeable composite membrane is formed from a porous support membrane and a polymer membrane. The polymer membrane is formed of at least one type of polymer (a) with a positive charge in the repeating unit and at least one type of polymer (b) with a negative charge in the repeating unit and has a crosslinked structure formed by siloxane bonds between the polymer (a) and the polymer (a), between the polymer (a) and the polymer (b), and/or between the polymer (b) and the polymer (b).

### TECHNICAL FIELD

The present invention relates to a semi-permeable composite membrane useful for selective separation of a liquid mixture.

### BACKGROUND ART

Regarding separation of a liquid mixture, various technologies exist for removing a substance dissolved in a solvent. Recently, membrane separation methods have been increasingly used as energy-saving and resource-saving processes. Of these methods, reverse osmosis membranes have been used for, for example, obtaining drinking water from seawater, brackish water, water containing a hazardous substance or the like, or producing ultra pure water for industrial use.

As a method for producing a membrane, there is a method in which a polymer having a positive charge and a polymer having a negative charge are brought into contact with each other on a substrate (Non-Patent Document 1). The membrane is a polyion complex membrane, and is advantageous in that the membrane is a uniform thin film having a thickness precisely controlled in a nanometer order. For this reason, use of polyion complex membranes as reverse osmosis membranes has been attempted (Non-Patent Documents 2 and 3). Moreover, a water treatment apparatus using a polyion complex membrane is also proposed (Patent Document 1).

However, polyion complex membranes have drawbacks of poor stability and durability. It is pointed out that, as a polyion complex membrane continues to be used, the desalination performance thereof deteriorates (Patent Document 2). Moreover, technologies for improving the desalination performance of a polyion complex membrane have been proposed; however, there is a concern about lack of durability due to detachment of the polymer having a positive charge and the polymer having a negative charge, because these polymers are adsorbed by only electrostatic interaction (Patent Documents 2, 3, and 4).

To overcome this concern, a polyion complex membrane has been proposed in which a polymer having a positive charge and a polymer having a negative charge are crosslinked by amide bonds by adding a coupling agent when the polymers are adsorbed (Patent Document 5). However, this approach causes such a concern that sufficient solute-removal performance cannot be obtained, because the charges on the polymers are reduced because of the reaction of the polymers with the coupling agent, and electrostatic interaction is inhibited. As described above, it is difficult to achieve both high membrane separation performance (solute-removal and water-permeation performances) and high durability by the conventional technologies.

### PRIOR ART DOCUMENT

### Patent Document

Patent Document 1: Japanese patent application Kokai publication No. 2000-334229 (Scope of Claims)
Patent Document 2: Japanese patent application Kokai publication No. 2005-230692 (Background Art, Scope of Claims)
Patent Document 3: Japanese patent application Kokai publication No. 2005-161293 (Scope of Claims)
Patent Document 4: Japanese patent application Kokai publication No. 2005-246263 (Scope of Claims)
Patent Document 5: International Application Japanese-Phase
Publication No. 2005-501758 (Scope of Claims)

### Non-Patent Document

Non-Patent Document 1: G. Decher and two others, “Thin Solid Films” 210/211, 1992, p. 831 to 835.
Non-Patent Document 2: R. von Klitzing, B. Tieke, “Advances in Polymer Science Vol. 165, Polyelectrolytes with Defined Molecular Architecture I”, Springer-Verlag Berlin, 2004, p. 177-210.
Non-Patent Document 3: B. Tieke and two others, “Langmuir” 19, 2003, p. 2550 to 2553.

### SUMMARY OF THE INVENTION

### Problem to be Solved by the Invention

An object of the present invention is to provide a semi-permeable composite membrane which exhibits both high durability and high solute-removal and water-permeation performances.

### Means for Solving the Problem

Siloxane bonds (Si—O—Si) are useful as means for crosslinking of polymers. Siloxane bonds are so stable that polymers having siloxane bonds, such as silicone resins, generally have high thermal and chemical stability. Here, the present inventors have conceived of impartment of stability and durability to a separation membrane by using siloxane bonds as means for crosslinking of a polyion complex membrane, and have reached the following invention.

(1) A semi-permeable composite membrane characterized by comprising:

a porous support membrane; and

a polymer membrane, wherein

the polymer membrane comprises at least one polymer (a) having a positive charge in a repeating unit and at least one polymer (b) having a negative charge in a repeating unit, and has a crosslinked structure formed by siloxane bonds between the polymer (a) and the polymer (a), between the polymer (a) and the polymer (b), and/or between the polymer (b) and the polymer (b).

(2) The semi-permeable composite membrane described in (1), wherein

at least one of the polymer (a) and the polymer (b) does not have a group of atoms which serves as a precursor of the siloxane bonds, and

the semi-permeable composite membrane is formed by bringing a crosslinking agent (c) into contact during or after a step of bringing the polymer (a) and the polymer (b) into contact with the porous support membrane, and further performing a drying step.

(3) The semi-permeable composite membrane described in (1), wherein

at least one of the polymer (a) and the polymer (b) has groups of atoms which serve as precursors of the siloxane bonds, and

the semi-permeable composite membrane is formed by performing a step of bringing the polymer (a) and the polymer (b) into contact with the porous support membrane, and then performing a drying step.

### Effects of the Invention

In the semi-permeable composite membrane of the present invention, at least one of a pair of the polymer (a) and the polymer (a), a pair of the polymer (a) and the polymer (b), and a pair of the polymer (b) and the polymer (b), which constitute the polymer membrane, are crosslinked by siloxane bonds. Hence, high durability and high solute-removal and water-permeation performances can be both achieved by the semi-permeable composite membrane. This semi-permeable composite membrane can be used preferably for, for example, reverse osmosis membrane separation such as desalination of seawater and brackish water, and softening of hard water.

### MODES FOR CARRYING OUT THE INVENTION

Hereinafter, an embodiment of the present invention will be described in detail.

A semi-permeable composite membrane of the present invention includes a porous support membrane and a polyion complex membrane. The polyion complex membrane is a polymer membrane in which a polymer having a positive charge and a polymer having a negative charge are adsorbed or bonded.

In the present invention, the porous support membrane has substantially no separation capability of ions and the like, and is provided to impart a strength to the polyion complex membrane which substantially has a separation capability. The size and distribution of pores in the porous support membrane are not particularly limited. For example, a preferable support membrane is such that the membrane has uniform fine pores, or fine pores which gets gradually larger from a surface on a polyion complex membrane-formation side to the other surface, and that the fine pores have a size of 0.1 nm or larger but 1 μm or smaller on the surface on the polyion complex membrane-formation side.

A material used for the porous support membrane and a shape of the porous support membrane are not particularly limited. An example of the material is a thin film formed by casting a resin onto a support (substrate). An example of the substrate is a fabric mainly made of at least one selected from polyesters and aromatic polyamides. As for the kind of the resin cast onto the substrate, for example, polysulfone, cellulose acetate, polyvinyl chloride, and mixtures thereof are preferably used, and it is particularly preferable to use polysulfone, which is highly stable chemically, mechanically, and thermally.

Specifically, the use of polysulfone having a repeating unit represented by the following structural formula is preferable, because the pore diameter can be controlled easily, and the dimensional stability is high.

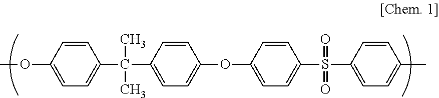

For example, a solution of the above-described polysulfone in N, N-dimethylformamide (hereinafter referred to as “DMF”) is cast onto a densely woven polyester fabric or a nonwoven fabric to have a uniform thickness, and the polysulfone is solidified in water in a wet manner. Thus, a porous support membrane in which most portions of the surface have fine pores with diameters of several tens nanometers or less can be obtained.

The morphology of the porous support membrane can be observed with a scanning electron microscope, a transmission electron microscope, or an atomic force microscope. For example, for the observation with a scanning electron microscope, the resin cast onto the substrate is peeled off therefrom, and then the resin is fractured by a freeze-fracturing method to prepare a sample for cross-sectional observation. This sample is thinly coated with platinum, platinum-palladium, or ruthenium tetrachloride, preferably with ruthenium tetrachloride, and observed with an ultra-high resolution field-emission scanning electron microscope (UHR-FE-SEM) at an acceleration voltage of 3 to 6 kV. An S-900 model electron microscope manufactured by Hitachi, Ltd., or the like can be used as the ultra-high resolution field-emission scanning electron microscope. The film thickness and the surface pore diameter of the porous support membrane are determined based on the obtained electron photomicrograph. Note that the thickness and the pore diameter in the present invention mean average values.

In the present invention, the polymer membrane constituting the polyion complex membrane is formed by a polymer (a) having a positive charge in a repeating unit and a polymer (b) having a negative charge in a repeating unit.

Here, the polymer (a) having a positive charge in a repeating unit refers to a polymeric substance having a cationic functional group in a repeating unit of its molecule. Examples of the polymer (a) include polyvinylamine, polyallylamine, polypyrrole, polyaniline, polyethylenimine, polyvinylimidazoline, polyvinylpyrrolidone, chitosan, polylysine, poly(p-phenylene)(+), poly(p-phenylene vinylene), salts thereof, poly(4-styrylmethyl)trimethylammonium salts, and the like. One kind of the polymers (a) may be used alone, or two or more kinds thereof may be used simultaneously. Moreover, a copolymer containing the polymer (a) may be used. Of these polymers (a), it is more preferable to use a copolymer containing a poly(4-styrylmethyl)trimethylammonium salt in consideration of selective separation performance, water-permeation performance, and heat resistance of the membrane.

The polymer (b) having a negative charge in a repeating unit refers to a polymeric substance having an anionic functional group in a repeating unit of its molecule. Examples of the polymer (b) include polyacrylic acid, polymethacrylic acid, polystyrenesulfonic acid, polyvinylsulfonic acid, polyglutamic acid, polyamic acid, polythiophene-3-acetic acid, salts thereof, and the like. One kind of the polymers (b) may be used alone, or two or more kinds thereof may be used simultaneously. Moreover, a copolymer containing the polymer (b) may be used. Of these polymers (b), it is more preferable to use a copolymer containing poly(sodium methacrylate), poly(sodium styrenesulfonate), or poly(potassium styrenesulfonate) in consideration of selective separation performance, water-permeation performance, and heat resistance of the membrane.

The polymer (a) and the polymer (b) each have a molecular weight preferably in a range from 1 to 1000 kDa. The molecular weight is further preferably in a range from 5 to 500 kDa, in order to form a uniform polymer layer and thus to secure the solute-removal performance of the semi-permeable composite membrane.

Moreover, it is important in the present invention that a crosslinked structure using siloxane bonds is present between the polymer (a) and the polymer (a), between the polymer (a) and the polymer (b), and/or between the polymer (b) and the polymer (b). The chemical crosslinking by stable siloxane bonds of polymers adsorbed only by electrostatic interaction makes it possible to provide the polyion complex membrane durable against an aqueous solution with a high ion concentration, a cleaning reagent including chlorine, and the like. For this crosslinking, it is necessary to introduce groups of atoms which serve as precursors of the siloxane bonds into the polymer, or to use a crosslinking agent which forms siloxane bonds.

Specifically, the polymer (a) having a positive charge in a repeating unit and/or the polymer (b) having a negative charge in a repeating unit may contain groups of atoms which serve as precursors of the siloxane bonds. Examples of the group of atoms which serves as a precursor of the siloxane bonds include groups of atoms having one or more of alkoxy groups, acetyloxy groups, alkylsilyloxy groups, amino groups, and halogeno groups on a silicon atom. These groups of atoms form silanol groups upon hydrolysis. The silanol groups are easily condensed by a crosslinking reaction described later to form siloxane bonds.

When neither the polymer (a) having a positive charge in a repeating unit nor the polymer (b) having a negative charge in a repeating unit has a group of atoms which serves as a precursor of the siloxane bonds, a crosslinking agent (c) is used in addition to these polymers. The crosslinking agent (c) can be used, also when one of the polymer (a) and the polymer (b) does not have a group of atoms which serves as a precursor of siloxane bonds. The crosslinking agent (c) is a silicon compound capable of reacting with two or more molecules of a compound having a proton of a hydroxyl group, a carboxyl group, an amino group, or the like to form crosslinking by siloxane bonds. Examples of the crosslinking agent (c) include compounds having two or more of isocyanate groups, alkoxy groups, acetyloxy groups, alkylsilyloxy groups, amino groups, and halogeno groups on a silicon atom.

Specifically, examples of the crosslinking agent (c) include tetraisocyanatesilane, monomethyltriisocyanatesilane, dimethyldiisocyanatesilane, ethyltriisocyanatesilane, diethyldiisocyanatesilane, tetramethoxysilane, tetraethoxysilane, tetraisopropoxysilane, tetrapropoxysilane, tetrabutoxysilane, tetrakis(dimethylsilyloxy)silane, 2-(3,4-epoxycyclohexyl)ethyltriethoxysilane, 2-(3,4-epoxycyclohexyl)ethyltrimethoxysilane, 2-cyanoethyltriethoxysilane, 2-cyanoethyltriethoxysilane, 3-(2-aminoethylamino)propyltriethoxysilane, 3-(2-aminoethylamino)propyltrimethoxysilane, 3-aminopropyltriethoxysilane, 3-aminopropyltrimethoxysilane, 3-chloropropyltriethoxysilane, 3-chloropropyltrimethoxysilane, 3-glycidyloxypropyltriethoxysilane, 3-glycidyloxypropyltrimethoxysilane, 3-bromopropyltriethoxysilane, 3-bromopropyltrimethoxysilane, 3-mercaptopropyltriethoxysilane, 3-mercaptopropyltrimethoxysilane, chloromethyltriethoxysilane, chloromethyltrimethoxysilane, cyclohexyltriethoxysilane, cyclohexyltrimethoxysilane, triethoxy(3,3,3-trifluoropropyl)silane, triethoxy(3-isocyanatopropyl)silane, triethoxy(3-isocyanatopropyl)silane, trimethoxy(3,3,3-trifluoropropyl)silane, bis[3-(triethoxysilyl)propyl]amine, bis[3-(trimethoxysilyl)propyl]amine, vinyltriethoxysilane, vinyltrimethoxysilane, ethyltrimethoxysilane, trimethoxymethylsilane, triethoxyethylsilane, triethoxymethylsilane, triethoxypropylsilane, trimethoxypropylsilane, butyltriethoxysilane, butyltrimethoxysilane, triethoxypentylsilane, trimethoxypentylsilane, triethoxyhexylsilane, hexyltrimethoxysilane, triethoxyheptylsilane, heptyltrimethoxysilane, triethoxyoctylsilane, trimethoxyoctylsilane, triethoxynonylsilane, trimethoxynonylsilane, triethoxydodecylsilane, dodecyltrimethoxysilane, benzyltriethoxysilane, benzyltrimethoxysilane, 1,2-bis(triethoxysilyl)ethane, 1,2-bis(trimethoxysilyl)ethane, 3-(2-aminoethylamino)propyldiethoxymethylsilane, 3-(2-aminoethylamino)propyldimethoxymethylsilane, 3-aminopropyldiethoxymethylsilane, 3-aminopropyldimethoxymethylsilane, 3-chloropropyldiethoxymethylsilane, 3-chloropropyldimethoxymethylsilane, 3-glycidyloxypropyl(diethoxy)methylsilane, 3-glycidyloxypropyl(dimethoxy)methylsilane, 3-mercaptopropyl(diethoxy)methylsilane, 3-mercaptopropyl(dimethoxy)methylsilane, cyclohexyl(diethoxy)methylsilane, cyclohexyl(dimethoxy)methylsilane, diethoxy(3-glycidyloxypropyl)methylsilane, diethoxy(3-glycidyloxypropyl)methylsilane, diethoxydimethylsilane, diethoxymethylvinylsilane, dimethoxydimethylsilane, dimethoxymethylvinylsilane, and the like. Of these crosslinking agents (c), tetraisocyanatesilane or monomethyltriisocyanatesilane is more preferably used in consideration of the reaction rate.

Next, a method for producing the semi-permeable composite membrane of the present invention is described.

The polyion complex membrane in the semi-permeable composite membrane of the present invention is formed by a polymer (a) having a positive charge in a repeating unit and a polymer (b) having a negative charge in a repeating unit. For example, the polyion complex membrane including a layer of the polymer having a positive charge and a layer of the polymer having a negative charge can be formed by bringing the porous support membrane into contact with each of solutions of the polymers.

Here, the concentration of each of the polymer solutions is preferably in a range from 0.01 to 100 mg/mL, and more preferably in a range from 0.1 to 10 mg/mL. When the concentrations are in this range, a polyion complex membrane having sufficient solute-removal and water-permeation performances can be obtained.

If necessary, the porous support membrane is chemically treated in advance in a usual manner to have a positive or negative charge. A first layer of the polyion complex membrane is formed as follows. Specifically, when the porous support membrane has a positive charge, the porous support membrane is first brought into contact with the polymer (b) having a negative charge. Meanwhile, when the porous support membrane has a negative charge, the porous support is first brought into contact with the polymer (a) having a positive charge. As for a method for this contact, the porous support membrane may be immersed in the polymer solution, or the polymer solution may be applied onto a surface of the porous support membrane. A contact time is preferably 1 second to 1 hour, and further preferably 10 seconds to 30 minutes for achieving both uniform surface coating and production efficiency.

If necessary, the membrane surface brought into contact with the polymer solution is washed with a solvent.

After the first layer of the polyion complex membrane is formed as described above, the membrane is brought into contact with a polymer solution for a second layer, and washed in the same manner. The polyion complex membrane can be formed by performing the contact and washing steps alternately for the polymer (a) having a positive charge and for the polymer (b) having a negative charge.

When at least one of the polymer (a) having a positive charge in a repeating unit and the polymer (b) having a negative charge in a repeating unit does not have a group of atoms which serves as a precursor of siloxane bonds, a crosslinking agent (c) can be used in addition to these polymers. Here, the crosslinking agent (c) may be added to the polymer solution simultaneously with the contact with the polymer solution, or the polyion complex membrane may be brought into contact with the crosslinking agent (c) after the contact with the polymer solution. A method for bringing the polyion complex membrane into contact with the crosslinking agent (c) after the contact with the polymer solution may be any of an immersion method, an application method, and the like. A contact time is preferably 1 second to 1 hour. The crosslinked reaction proceeds sufficiently by setting the contact time to 1 second to 1 hour.

In the present invention, the thus obtained polyion complex membrane is subjected to a crosslinking reaction. Thus, crosslinking by covalent bonds is achieved between the polymer (a) and the polymer (a), between the polymer (a) and the polymer (b), and/or between the polymer (b) and the polymer (b), in particular between the polymer (a) having a positive charge and the polymer (b) having a negative charge. This provides the polyion complex membrane with durability against an aqueous solution with a high ion concentration, a cleaning reagent including chlorine, and the like.

In the present invention, a step of drying in a range from room temperature to 150° C. for 1 minute to 48 hours is preferably employed as a drying step for causing the crosslinking reaction by siloxane bonds to proceed. At 150° C. or above, the performance of the porous support membrane made of polysulfone seems to deteriorate. In the range from 1 minute to 48 hours, the crosslinking reaction can be caused to proceed without lowering the production efficiency. In addition, the drying may be conducted at normal pressure or under vacuum.

The thus formed semi-permeable composite membrane of the present invention is used preferably as a spiral-type semi-permeable composite membrane element, by being wound around a tubular water collection pipe having many pores formed therein, together with a raw water flow path member of a plastic net or the like, a permeate water flow path member of tricot or the like, and, if necessary, a film for increasing the pressure resistance. Moreover, a semi-permeable composite membrane module may be formed by connecting such elements in series or in parallel, and housing the elements in a pressure vessel.

In addition, a fluid separation apparatus can be constructed by combining the semi-permeable composite membrane, the element thereof, or the module thereof with a pump for supplying raw water, an apparatus for pretreatment of the raw water, and the like. The use of this separation apparatus enables water which meets purposes to be obtained by separating the raw water into permeate water such as drinking water and concentrate water not permeating the membrane.

A higher operation pressure of the fluid separation apparatus leads to a more improved salt rejection thereof. However, in consideration of the increase in the energy required for operating the fluid separation apparatus, and of the durability of the semi-permeable composite membrane, the operation pressure at the time of permeation of treatment target water through the semi-permeable composite membrane is preferably 0.1 MPa or higher but 10 MPa or lower. As the temperature of the treatment target water rises, the salt rejection is lowered. Meanwhile, as the temperature is lowered, the membrane permeation flux also decreases. For these reasons, the temperature of the treatment target water is preferably 5° C. or above but 45° C. or below. In addition, when the pH of feed water (treatment target water) is high, scale of magnesium or the like may be formed in a case where the feed water is seawater with a high salt concentration or the like. In addition, the semi-permeable composite membrane may deteriorate due to the high-pH operation. Hence, an operation in a neutral region is preferable.

Examples of the raw water (treatment target water) to be treated with the semi-permeable composite membrane of the present invention include liquid mixtures containing 500 mg/L to 100 g/L of salts such as seawater, brackish water, and wastewater.

### EXAMPLES

Hereinafter, the present invention will be described in further detail based on Examples. However, the present invention is not limited to these Examples at all.

The characteristics of membranes of Examples and Comparative Examples were determined as follows. Specifically, an aqueous solution of sodium chloride or an aqueous solution of magnesium sulfate adjusted to have a concentration of 1000 ppm, a temperature of 25° C., and a pH of 6.5 was fed to each semi-permeable composite membrane at an operation pressure of 0.5 MPa, and a membrane filtration was conducted. Then, the qualities of the permeate water and the feed water were measured.

(Salt Rejection)

Salt Rejection (%)=100×[1−(salt concentration in permeate water/salt concentration in feed water)]

(Membrane Permeation Flux)

An amount of feed water permeating through a membrane was represented by an amount (liter) of permeate water per one square meter of membrane surface, per hour, and per unit (L/m²/h/bar).

### Example 1

A copolymer of poly(4-styrylmethyl)trimethylammonium and poly(3-methacryloxypropyltrimethoxysilane) at a weight ratio of 95:5 was synthesized as the polymer (a) having a positive charge in a repeating unit. In 30 mL of anhydrous toluene, 20 g of chloromethylstyrene and 1.05 g of 3-methacryloxypropyltrimethoxysilane were dissolved. To this solution, 65 mg of azobisisobutyronitrile was added, and the mixture was stirred under a nitrogen atmosphere at 70° C. for 24 hours. Reprecipitation was conducted by adding dropwise 1 mL of this solution to 50 mL of methanol, the precipitates were dissolved in 50 mL of tetrahydrofuran, and trimethylamine was added dropwise thereto. The target copolymer was obtained as precipitates.

A copolymer of poly(sodium p-styrenesulfonate) and poly(4-hydroxybutyl acrylic acid) at a weight ratio of 95:5 was synthesized as the polymer (b) having a negative charge in a repeating unit. In 30 mL of distilled water, 12 g of sodium p-styrenesulfonate and 0.63 g of 4-hydroxybutyl acrylic acid were dissolved. To the solution, 0.48 g of ammonium persulfate was added, and the mixture was stirred at 70° C. for 24 hours. Reprecipitation was conducted by adding 1 mL of this solution dropwise to 50 mL of methanol. Thus, the target copolymer was obtained.

A 15.7 wt % solution of polysulfone in DMF was cast to a thickness of 200 μm onto a polyester nonwoven fabric (air permeability: 0.5 to 1 mL/cm²/sec) at room temperature (25° C.). The materials were immediately immersed in pure water, and allowed to stand for 5 minutes. Thus, a porous support membrane was fabricated.

The thus obtained porous support membrane (thickness: 210 to 215 μm) was immersed for 30 minutes in a polymer solution obtained by diluting 10-fold a 10 mg/mL aqueous solution of the polymer (a) with a 50 mM NaCl-imidazole solution, and then the membrane was washed with pure water. Subsequently, the membrane was immersed for 30 minutes in a polymer solution obtained by diluting 10-fold a 10 mg/mL aqueous solution of the polymer (b) with a 50 mM NaCl-imidazole solution, and adding 50 μL of tetraisocyanatesilane thereto, and then the membrane was washed with pure water. The operations of immersion in the two polymer solutions were alternately repeated 8 times in total, and thus a polyion complex membrane was obtained. This membrane was dried at room temperature under vacuum for 24 hours to perform a crosslinking reaction. After that, the membrane was immersed in a 10 wt. % aqueous solution of isopropyl alcohol for 3 hours, and then washed with pure water.

To evaluate stability against salt, the membrane was immersed in a 3 M aqueous solution of NaCl at room temperature for 6 hours. After that, the membrane was washed with pure water.

Separately, to evaluate stability against chlorine, the membrane was immersed in an aqueous solution of sodium hypochlorite (NaClO: 200 ppm, CaCl₂: 500 ppm, pH: 7) at room temperature for 24 hours. After that, the membrane was washed with pure water.

Table 1 shows evaluation results of the salt rejections and the water-permeation performance of each of the base membrane after the crosslinking reaction, the membrane after the immersion in the aqueous solution of NaCl, and the membrane after the immersion in the aqueous solution of sodium hypochlorite.

### Comparative Example 1

A membrane was produced in the same manner as in Example 1, except that no tetraisocyanatesilane was added, and the crosslinking reaction by drying for 24 hours was not conducted. Table 1 shows evaluation results of the salt rejections and the water-permeation performance in the case where immersion in a NaCl solution or an aqueous solution of sodium hypochlorite was conducted in the same manner.

TABLE 1

| | Before immersion | | | After immersion in | | | After immersion in an aqueous | | |
|---|---|---|---|---|---|---|---|---|---|
| | (base membrane) | | | NaCl solution | | | solution of sodium hypochlorite | | |
| | Membrane | | | Membrane | | | Membrane | | |
| | permeation | NaCl | MgSO₄ | permeation | NaCl | MgSO₄ | permeation | NaC1 | MgSO₄ |
| | flux | Rejection | Rejection | flux | Rejection | Rejection | flux | Rejection | Rejection |
| | [L/m²/h/bar] | [%] | [%] | [L/m²/h/bar] | [%] | [%] | [L/m²/h/bar] | [%] | [%] |
| Example 1 | 5.1 | 39 | 83 | 5.8 | 36 | 81 | 5.9 | 35 | 76 |
| Comparative | 6.3 | 37 | 80 | 55.9 | 6 | 23 | 40.3 | 10 | 32 |
| Example 1 | | | | | | | | | |

No remarkable deterioration in performance of the membrane of Example 1 was observed even after the membrane was immersed in the NaCl solution and the aqueous solution of sodium hypochlorite. In contrast, the rejections of the membrane of Comparative Example 1 which was not subjected to the crosslinking treatment greatly deteriorated, when the membrane was immersed in the solution of NaCl or the aqueous solution of sodium hypochlorite. As described above, the semi-permeable composite membrane obtained by the present invention has high durability which cannot be achieved by conventional polyion complex membranes.

### Example 2

A copolymer of poly(4-styrylmethyl)trimethylammonium and poly(3-methacryloxypropyltrimethoxysilane) at a weight ratio of 95:5 was synthesized as the polymer (a) having a positive charge in a repeating unit as follows. In 30 mL of anhydrous toluene, 20 g of chloromethylstyrene and 1.05 g of 3-methacryloxypropyltrimethoxysilane were dissolved. To this solution, 65 mg of azobisisobutyronitrile was added, and the mixture was stirred under a nitrogen atmosphere at 70° C. for 24 hour. Reprecipitation was conducted by adding dropwise 1 mL of this solution to 50 mL of methanol, the precipitates were dissolved in 50 mL of tetrahydrofuran, and trimethylamine was added dropwise thereto. The target copolymer was obtained as precipitates.

A copolymer of poly(sodium p-styrenesulfonate) and poly(3-methacryloxypropyltrimethoxysilane) at a weight ratio of 95:5 was synthesized as the polymer (b) having a negative charge in a repeating unit as follows. In 120 mL of anhydrous dimethyl sulfoxide, 12 g of sodium p-styrenesulfonate and 0.63 g of 3-methacryloxypropyltrimethoxysilane were dissolved. To this solution, 0.48 g of ammonium persulfate was added, and the mixture was stirred at 70° C. for 24 hours. Reprecipitation was conducted by adding dropwise 4 mL of this solution to 200 mL of methanol. Thus, the target copolymer was obtained.

A 15.7 wt % solution of polysulfone in DMF was cast to a thickness of 200 μm onto a polyester nonwoven fabric (air permeability: 0.5 to 1 mL/cm²/sec) at room temperature (25° C.). The materials were immediately immersed in pure water, and allowed to stand for 5 minutes. Thus, a porous support membrane was fabricated.

The thus obtained porous support membrane (thickness: 210 to 215 μm) was immersed for 30 minutes in a polymer solution obtained by diluting 10-fold a 10 mg/mL aqueous solution of the polymer (a) with a 50 mM NaCl-imidazole solution, and then the membrane was washed with pure water. Subsequently, the membrane was immersed for 30 minutes in a polymer solution obtained by diluting 10-fold a 10 mg/mL aqueous solution of the polymer (b) with a 50 mM NaCl-imidazole solution, and then the membrane was washed with pure water. The operations of immersion in the two polymer solutions were alternately repeated for 8 times in total, and thus a polyion complex membrane was obtained. This membrane was dried at room temperature under vacuum for 24 hours to perform a crosslinking reaction. After that, the membrane was immersed in a 10 wt % aqueous solution of isopropyl alcohol for 3 hours, and then washed with pure water.

To evaluate stability against salt, the membrane was immersed in a 3M aqueous solution of NaCl at room temperature for 6 hours. After that, the membrane was washed with pure water.

Separately, to evaluate stability against chlorine, the membrane was immersed in an aqueous solution of sodium hypochlorite (NaClO: 200 ppm, CaCl₂: 500 ppm, pH: 7) at room temperature for 24 hours. After that, the membrane was washed with pure water.

Table 2 shows evaluation results of the salt rejections and the water-permeation performance of each of the base membrane after the crosslinking reaction, the membrane after the immersion in the NaCl aqueous solution, and the membrane after the immersion in the aqueous solution of sodium hypochlorite.

### Comparative Example 2

A membrane was produced in the same manner as in Example 2, except that poly(4-styrylmethyl)trimethylammonium was used as the polymer (a) having a positive charge in a repeating unit, and that poly(sodium p-styrenesulfonate) was used as the polymer (b) having a negative charge in a repeating unit. Table 2 shows evaluation results of the salt rejections and the water-permeation performance obtained in the case where immersion in a NaCl solution or an aqueous solution of sodium hypochlorite was conducted in the same manner.

TABLE 2

| | Before immersion | | | After immersion in | | | After immersion in an aqueous | | |
|---|---|---|---|---|---|---|---|---|---|
| | (base membrane) | | | NaCl solution | | | solution of sodium hypochlorite | | |
| | Membrane | | | Membrane | | | Membrane | | |
| | permeation | NaCl | MgSO₄ | permeation | NaCl | MgSO₄ | permeation | NaCl | MgSO₄ |
| | flux | Rejection | Rejection | flux | Rejection | Rejection | flux | Rejection | Rejection |
| | [L/m²/h/bar] | [%] | [%] | [L/m²/h/bar] | [%] | [%] | [L/m²/h/bar] | [%] | [%] |
| Example 2 | 4.0 | 50 | 85 | 4.3 | 47 | 80 | 4.9 | 45 | 73 |
| Comparative | 5.2 | 45 | 82 | 62.0 | 5 | 18 | 45.2 | 8 | 26 |
| Example 2 | | | | | | | | | |

No remarkable deterioration in performance of the membrane of Example 2 was observed even after the membrane was immersed in the NaCl solution and the aqueous solution of sodium hypochlorite. In contrast, the rejections of the membrane of Comparative Example 2 incapable of forming siloxane bonds greatly deteriorated, when the membrane was immersed in the solution of NaCl or the aqueous solution of sodium hypochlorite. Accordingly, the semi-permeable composite membrane obtained by the present invention has high durability which cannot be achieved by conventional polyion complex membranes.

### INDUSTRIAL APPLICABILITY

The present invention can be preferably used for semi-permeable membranes, and in particular reverse osmosis membranes, which are useful for desalination of brackish water and seawater, as well as softening of hard water, and the like.

1. A semi-permeable composite membrane characterized by comprising:
a porous support membrane; and
a polymer membrane, wherein the polymer membrane comprises at least one polymer (a) having a positive charge in a repeating unit and at least one polymer (b) having a negative charge in a repeating unit, and has a crosslinked structure formed by siloxane bonds between the polymer (a) and the polymer (a), between the polymer (a) and the polymer (b), and/or between the polymer (b) and the polymer (b).

2. The semi-permeable composite membrane according to claim 1, wherein
at least one of the polymer (a) and the polymer (b) does not have a group of atoms which serves as a precursor of the siloxane bonds, and
the semi-permeable composite membrane is formed by bringing a crosslinking agent (c) into contact during or after a step of bringing the polymer (a) and the polymer (b) into contact with the porous support membrane, and further performing a drying step.

3. The semi-permeable composite membrane according to claim 1, wherein
at least one of the polymer (a) and the polymer (b) has groups of atoms which serve as precursors of the siloxane bonds, and
the semi-permeable composite membrane is formed by performing a step of bringing the polymer (a) and the polymer (b) into contact with the porous support membrane, and then performing a drying step.
